(19) United States
(12) Patent Application Publication
(10) Pub. No.: US 2008/0059934 A1
(43) Pub. Date: Mar. 6, 2008

(54) Apparatus and method for designing semiconductor devices

(75) Inventor: Masahiko Igeta, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 11/896,303

(22) Filed: Aug. 30, 2007

(30) Foreign Application Priority Data
Aug. 31, 2006 (JP) 2006-235836

(51) Int. Cl. G06F 17/50

(52) U.S. Cl. 716/13

(57) ABSTRACT

Apparatus and method for designing semiconductor devices enabling to design layout of through-holes automatically between same-potential upper- and lower-layer power wiring traces without omissions and with a minimum labor. Area of overlap between same-potential, different-layer power wiring traces is extracted from designed power wiring traces. In order to detect area in which through-holes can be placed, at least one of the same-potential, different-layer power wiring traces is enlarged without touching a different-potential, same-potential wiring trace, thereby enlarging the overlap area, which is then extracted. Further, by enlarging one of the same-potential, different-layer power wiring traces without touching a different-potential, a new overlap area is formed and extracted. Through-holes are placed in the overlap area extracted.

### REFERENCE TO RELATED APPLICATION

The present application is claiming the priority of the earlier Japanese patent application No. 2006-235836 filed on Aug. 31, 2006, the entire disclosure thereof being incorporated herein by reference thereto.

### FIELD OF THE INVENTION

This invention relates to an apparatus and method for designing semiconductor devices. More particularly, the invention relates to an apparatus and method for designing semiconductor devices whereby through-holes (inclusive of vias and contacts, etc.) are laid out automatically.

### BACKGROUND OF THE INVENTION

Power wiring in a semiconductor device is separated into wiring for power and wiring for ground on a per-circuit-function basis, and a plurality of potentials are assigned in such a manner that noise will not propagate between wiring traces. Upper-layer power wiring and lower-layer power wiring exists for each potential, and there are many locations in same-potential power wiring where upper-layer power wiring and lower-level power wiring cross. In order to reinforce the power supply, through-holes are placed at the locations where the same-potential, upper-layer power wiring and same-potential, lower-layer power wiring cross.

In a method of revising the design of transistor cells set forth in Patent Document 1, any of the following expedients for strengthening power wiring is adopted in order to shorten design time: addition of strengthening vias connecting lower-layer power wiring and upper-layer power wiring, enlargement of the width of the upper-layer power wiring, or addition of capacitor cell(s) connected to the upper-layer power wiring.

[Patent Document 1]

Japanese Patent Application Kokai Publication No. JP-P2004-281698A

### SUMMARY OF THE DISCLOSURE

The entire disclosures of the above mentioned Patent Document are herein incorporated by reference thereto. The following analysis is given by the present invention.

In the designing of semiconductor devices, the locations at which through-holes are placed are decided visually. With such manual placement relying upon vision, however, it is inevitable that the designer will forget some locations at which the through-holes should be placed. In addition, at locations that have too little space to allow the placement of through-holes or at locations where power wiring has not been formed, it is difficult to revise the power wiring so as to enable the placement of the through-holes with the manual placement method. Hence, through-holes cannot be placed without omissions. Furthermore, manual placement of through-holes is extremely laborious and involves a great deal of time and expense.

Accordingly, it is an object of the present invention to provide an apparatus and method for designing semiconductor devices whereby through-holes can be laid out automatically between same-potential upper-layer power wiring and lower-layer potential wiring without placement omissions and with minimal labor.

According to a first aspect of the present invention, there is provided a method of designing a semiconductor device, comprising: a same-potential, different-layer power wiring extraction step of extracting same-potential, different-layer power wiring traces from among power wiring traces that have been designed; an overlap-area extraction step of extracting an overlap area in which the same-potential, different-layer power wiring traces overlap each other in a planar projection of the same-potential, different-layer power wiring traces that have been extracted; an overlap-area enlargement step of enlarging the overlap area by enlarging at least one of the same-potential, different-layer power wiring traces without this wiring trace being allowed to touch a different-potential, same-layer wiring trace; and a through-hole layout step of laying out through-holes in the overlap area.

According to a second aspect of the present invention, there is provided a method of designing a semiconductor device, comprising: a same-potential, different-layer power wiring extraction step of extracting same-potential, different-layer power wiring traces from among power wiring traces that have been designed; an overlap-area extraction step of extracting an overlap area in which the same-potential, different-layer power wiring traces overlap each other in a planar projection of the same-potential, different-layer power wiring traces that have been extracted; an overlap-area formation step of forming a new overlap area by enlarging at least one of the same-potential, different-layer power wiring traces without this wiring trace being allowed to touch a different-potential, same-layer wiring trace; and a through-hole layout step of laying out through-holes in the overlap area.

According to a third aspect of the present invention, there is provided a method of designing a semiconductor device, comprising: a same-potential, different-layer power wiring extraction step of extracting same-potential, different-layer power wiring traces from among power wiring traces that have been designed; an overlap-area extraction step of extracting an overlap area in which the same-potential, different-layer power wiring traces overlap each other in a planar projection of the same-potential, different-layer power wiring traces that have been extracted; an overlap-area enlargement step of enlarging the overlap area by enlarging at least one of the same-potential, different-layer power wiring traces without this wiring trace being allowed to touch a different-potential, same-layer wiring trace; an overlap-area formation step of forming a new overlap area by enlarging at least one of the same-potential, different-layer power wiring traces without this wiring trace being allowed to touch a different-potential, same-layer wiring trace; and a through-hole layout step of laying out through-holes in the overlap areas.

According to a fourth aspect of the present invention, there is provided a method of designing a semiconductor device, comprising: a same-potential, different-layer power wiring extraction step of extracting same-potential, different-layer power wiring traces from among power wiring traces that have been designed; a power wiring enlargement step of enlarging at least one of the same-potential, different-layer power wiring traces without this wiring trace being allowed to touch a different-potential, same-layer wiring trace; after the power wiring enlargement step, an overlap-area extraction step of extracting an overlap area in which the same-potential, different-layer power wiring traces overlap each other in a planar projection of the same-potential, different-layer power wiring traces that have been extracted; and a through-hole layout step of laying out through-holes in the overlap area.

According to a preferred example of the fourth aspect of the present invention, the method of designing a semiconductor device further comprises a power wiring enlargement cancellation step executed after the power wiring enlargement step if a portion enlarged by the power wiring enlargement step in the same-potential, different-layer power wiring does not form the overlap area, the power wiring enlargement cancellation step canceling enlargement of the power wiring in the portion that does not form the overlap area to restore a condition that prevailed prior to the enlargement.

According to a fifth aspect of the present invention, there is provided an apparatus for designing a semiconductor device, comprising: a same-potential, different-layer power wiring extraction function that extracts same-potential, different-layer power wiring traces from among power wiring traces that have been designed; an overlap-area function that extracts an overlap area in which the same-potential, different-layer power wiring traces overlap each other in a planar projection of the same-potential, different-layer power wiring traces that have been extracted; a power-wiring enlargement determination function that determines whether it is possible to enlarge the same-potential, different-layer power wiring without this power wiring touching different-potential, same-layer wiring, whether it is possible to enlarge the overlap area by enlarging the same-potential, different-layer power wiring, and whether it is possible to form an overlap area anew by enlarging the same-potential, different-layer power wiring; a power-wiring revision function that enlarges the same-potential, different-layer power wiring and cancels enlargement based upon result of determination by the power-wiring enlargement determination function; and a through-hole layout function that lays out through-holes in the overlap area.

According to a preferred example of the fifth aspect of the present invention, the apparatus for designing a semiconductor device further comprises an overlap-area size detection function that detects the size of the overlap area; a through-hole layout determination function that determines whether through-holes are capable of being placed in the overlap area; and a through-hole number calculation function that calculates the number of through-holes capable of being placed in the overlap area.

The meritorious effects of the present invention are summarized as follows.

In accordance with the first aspect of the present invention, the originally designed area in which through-holes are capable of being placed can be enlarged to the maximum extent, and the number of through-holes laid out can be increased. In particular, through-holes can be placed in an overlap area that was originally too small to allow the placement of through-holes.

In accordance with the second aspect of the present invention, a through-hole placement area that did not exist in the original design can be formed anew, and the number of through-holes laid out can be increased.

In accordance with the third aspect of the present invention, the originally designed area in which through-holes are capable of being placed can be enlarged to the maximum extent, and a through-hole placement area that did not exist in the original design can be formed anew. As a result, the number of through-holes laid out can be increased.

In accordance with the fourth aspect of the present invention, a through-hole placement area that potentially exists in the original design can be found more efficiently with a fewer number of steps.

In accordance with the fifth aspect of the present invention, locations in the original design that lack through-holes and a through-hole placement area that potentially exists in the original design can be found in a short time. As a result, the quality of the semiconductor device designed can be improved.

In accordance with the first to fifth aspects of the present invention, a potentially existing through-hole placement area can be embodied, the number of through-holes laid out can be increased and locations where through-holes have been omitted can be reduced or eliminated. As a result, the power supply is reinforced over the entirety of the semiconductor device and the quality of the semiconductor device is improved. Furthermore, design time, labor and cost required for the placement of through-holes can be reduced by a wide margin.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIGS. 1A and 1B are block diagrams illustrating the structure of an apparatus for designing a semiconductor device according to a first example of the present invention;

FIGS. 2A and 2B constitute a flowchart illustrating a method of designing a semiconductor device according to the first example;

FIG. 3 is a planar projection diagram illustrating an example of an area of overlap between same-potential, different-layer power wiring traces;

FIG. 4 is a planar projection diagram illustrating an example of an area of overlap between same-potential, different-layer power wiring traces;

FIGS. 5A, 5B and 5C are planar projection diagrams illustrating examples of areas of overlap between same-potential, different-layer power wiring traces;

FIGS. 6A, 6B and 6C are planar projection diagrams illustrating examples of areas of overlap between same-potential, different-layer power wiring traces;

FIGS. 7A, 7B and 7C are planar projection diagrams illustrating examples of areas of overlap between same-potential, different-layer power wiring traces;

FIGS. 8A, 8B and 8C are planar projection diagrams illustrating examples of areas of overlap between same-potential, different-layer power wiring traces;

FIG. 9 is a flowchart illustrating a method of designing a semiconductor device according to a second example of the present invention;

FIG. 10 is a flowchart illustrating a method of designing a semiconductor device according to a third example of the present invention; and

FIGS. 11A to 11D are planar projection diagrams of power wiring useful in describing a method of designing a semiconductor device according to the third example.

### PREFERRED MODES OF THE INVENTION

An apparatus and method for designing a semiconductor device according to a first example of the present invention will be described in detail. The apparatus will be described first.

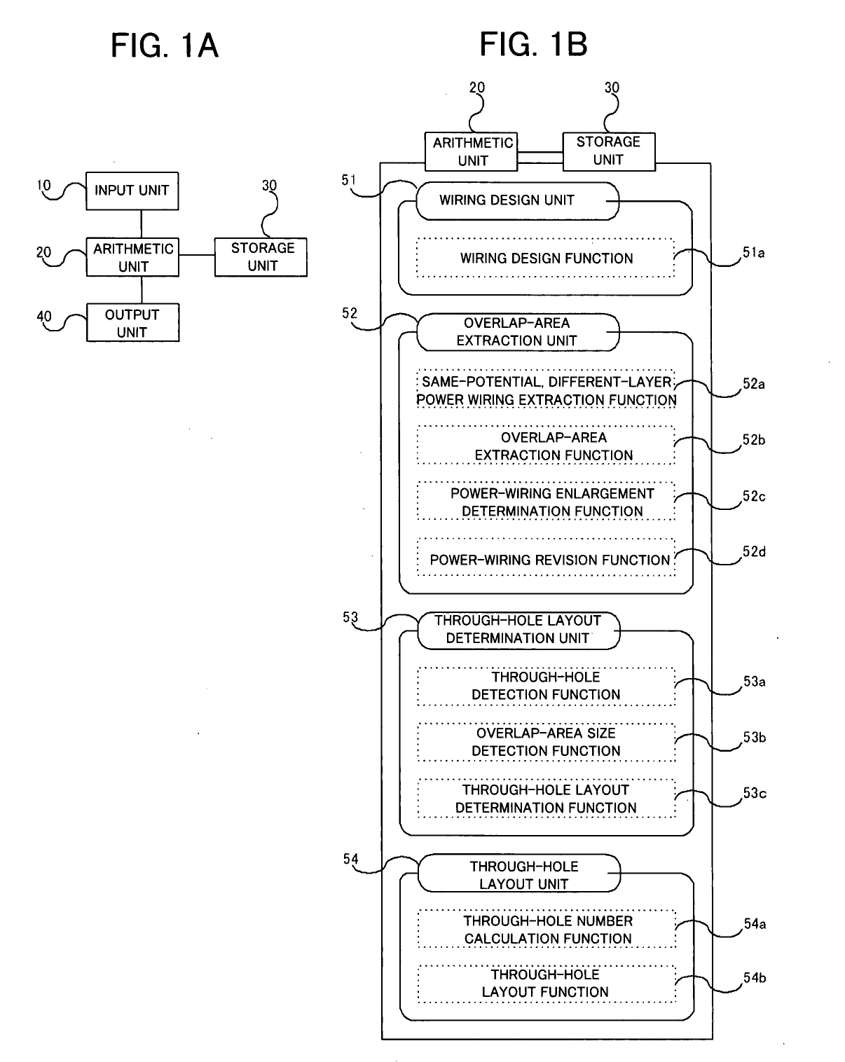

FIGS. 1A and 1B are block diagrams illustrating the structure of an apparatus for designing a semiconductor device according to a first example of the present invention. As illustrated in FIG. 1A, the apparatus comprises an input unit 10 for inputting wiring data, etc., an arithmetic unit 20 that executes processing for designing a semiconductor device and various processing for laying out through-holes automatically, a storage unit 30 for storing wiring data, results of processing and programs, etc., and an output unit 40 for outputting and displaying wiring data, etc. The apparatus further includes a communication device, not shown. The input unit 10 includes various input devices such as a keyboard, mouse and touch-sensitive panel. The output unit 40 includes various output devices such as a display and printer. The arithmetic unit 20 includes various arithmetic devices such as a CPU. The storage unit 30 includes various storage devices such as a memory and hard disk.

As illustrated in FIG. 1B, the arithmetic unit 20 and storage unit 30 have wiring design unit 51 for designing wiring of a semiconductor device; overlap-area extraction unit 52 for extracting an area, which is for laying out through-holes, from a plurality of power wiring traces; through-hole layout determination unit 53 for determining whether a through-hole is capable of being placed in the overlap area extracted by the overlap-area extraction unit 52; and through-hole layout unit 54 for laying out through-holes in the overlap area. The wiring design unit 51 has a wiring design function 51a equipped with various functions for designing wiring of the semiconductor device. The overlap-area extraction unit 52 includes a same-potential, different-layer power wiring extraction function (i.e., functional unit) 52a for extracting power wiring of the same potential from power wiring in a plurality of different layers; an overlap-area extraction function 52b for extracting an overlap area in which same-potential, different-layer power wiring traces overlap in a planar projection of the same-potential, different-layer power wiring that has been extracted; a power-wiring enlargement determination function 52c for determining whether the power wiring is capable of being enlarged (e.g., without touching different-potential, same-layer wiring) and whether an overlap area is capable of being enlarged or formed; and a power-wiring revision function 52d for enlarging the power wiring or canceling enlargement of the power wiring based upon result of the determination made by the power-wiring enlargement determination function 52c. The through-hole layout determination unit 53 includes a through-hole detection function 53a for detecting whether a through-hole is present in the overlap area of same-potential, different-layer power wiring; an overlap-area size detection function 53b for detecting longitudinal and transverse sizes of the overlap area; and a through-hole layout determination function 53c for determining whether a through-hole is capable of being placed in the overlap area. The through-hole layout unit 54 includes a through-hole number calculation function 54a for calculating the number of through-holes capable of being placed in the overlap area, and a through-hole layout function 54b for laying out through-holes in the overlap area. The above-mentioned units and functions can be implemented as functional units provided in the design apparatus of the present invention.

Recorded in the storage unit 30 is a program for causing the design apparatus of the present invention to execute the design method of the invention. The program causes the apparatus to implement functions such as the wiring design function, same-potential, different-layer power wiring extraction function, overlap-area extraction function, power-wiring enlargement determination function, power-wiring revision function, through-hole detection function, overlap-area size detection function, through-hole layout determination function, through-hole number calculation function and through-hole layout function.

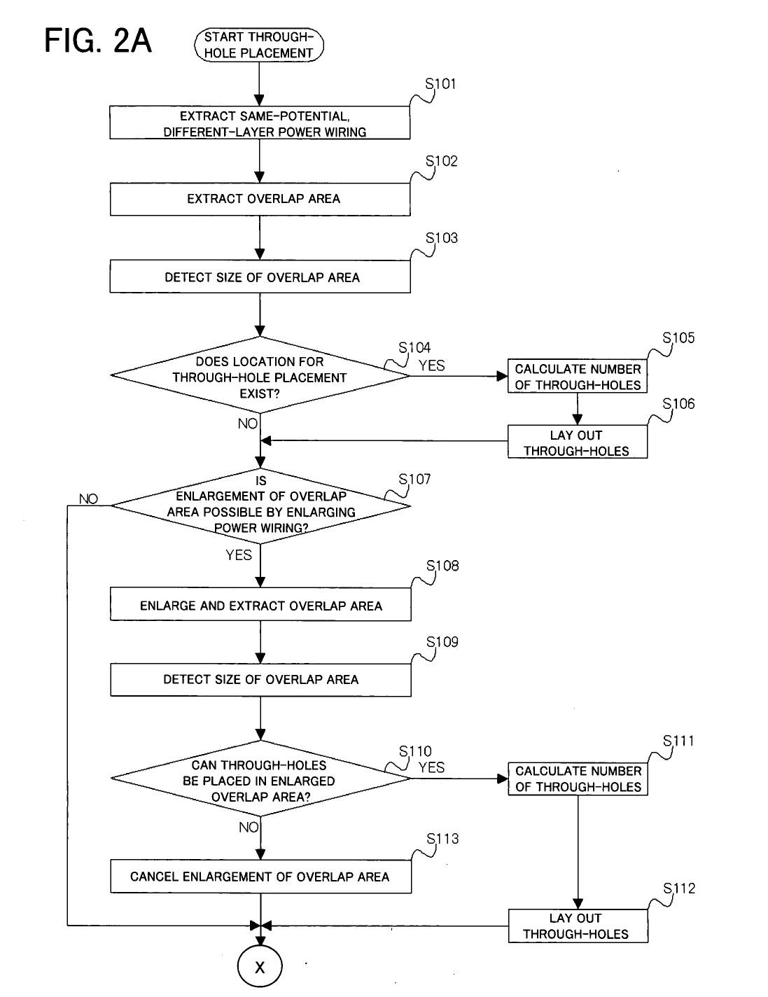

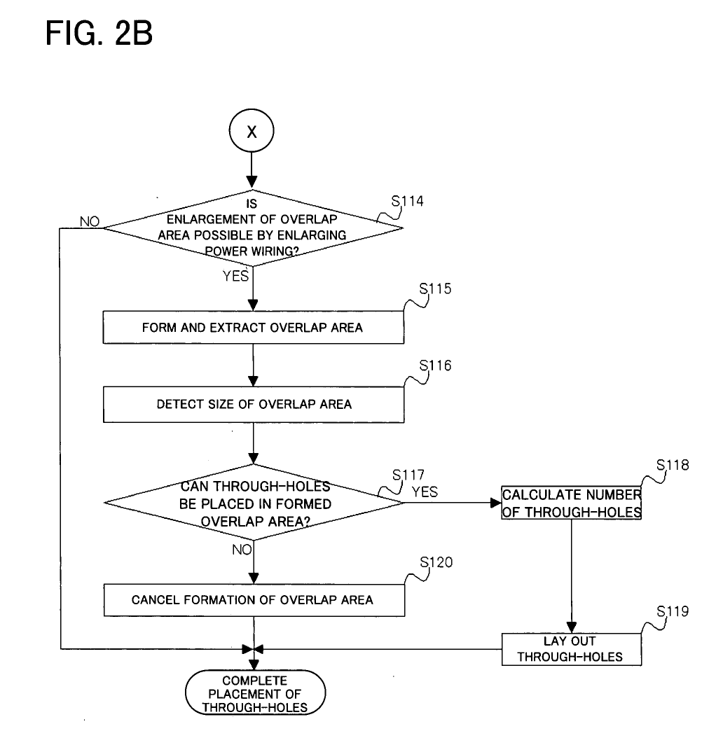

The method of designing a semiconductor device according to the first example will now be described together with the above-mentioned functions. FIGS. 2A and 2B constitute a flowchart illustrating the method of designing a semiconductor device according to a first example. First, at step S101 (extract same-potential, different-layer power wiring), a plurality of same-potential, different-layer power wiring traces are extracted from designed power wiring traces (of primary design) by the same-potential, different-layer power wiring extraction function 52a. Next, at step S102 (extract overlap area), an area (overlap area or areas) in which those of the extracted plurality of same-potential, different-layer power wiring traces overlap as seen from the perspective of a planar projection is extracted by the overlap-area extraction function 52b. Here the “overlap area” is an area 73 (indicated by the mesh portion in FIG. 3) of overlap between upper-layer power wiring 71 and lower-layer power wiring 72 constituting a plurality of same-potential, different-layer power wiring traces.

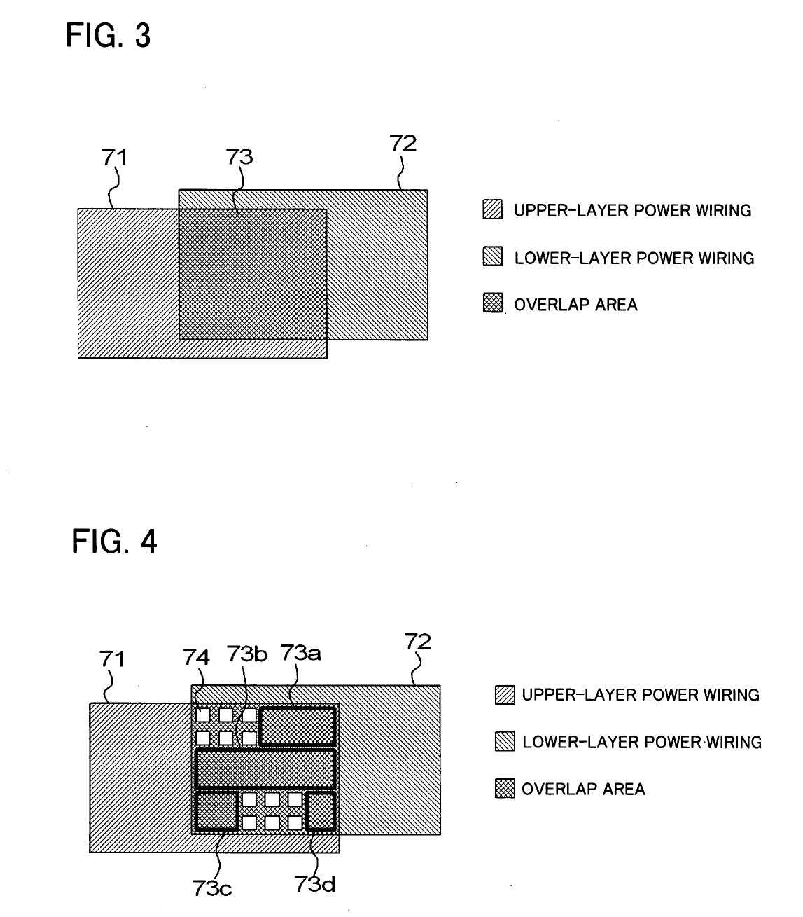

Next, at step S103 (detect overlap-area size), the X-direction (transverse) and Y-direction (vertical) sizes of available space in the overlap area extracted at step S102 are detected. By way of example, assume a case where through-holes 74 have already been placed in part of the area of overlap between the upper-layer power wiring 71 and lower-layer power wiring 72, as illustrated in FIG. 4. In this case, the region in which the through-holes have been placed and the region in which through-holes have not been placed are detected by the through-hole detection function 53a (this is a through-hole detection step). If the region in which the through-holes 74 have not been placed is rectangular, then this is detected as a region in which through-holes can be placed and the size thereof is detected with the shape of the region being left as is. If the region is not rectangular, then it is divided into a plurality of rectangular regions, as illustrated in FIG. 4, these are detected as overlap areas 73a to 73d and the size of each area is detected.

Next, at step S104 (determine through-hole layout), it is determined by the through-hole layout determination function 53c whether through-holes can be placed in the detected overlap area. If it is determined that through-holes can be placed in the overlap area, then the number of through-holes that can be placed in the overlap area is calculated at step S105 (calculate number of through-holes) by the through-hole number calculation function 54a. At step S106 (lay out through-holes), through-holes are placed in the overlap area by the through-hole layout function 54b. On the other hand, if it is determined that through-holes cannot be laid out because of inadequate space, etc., then control proceeds to step S107.

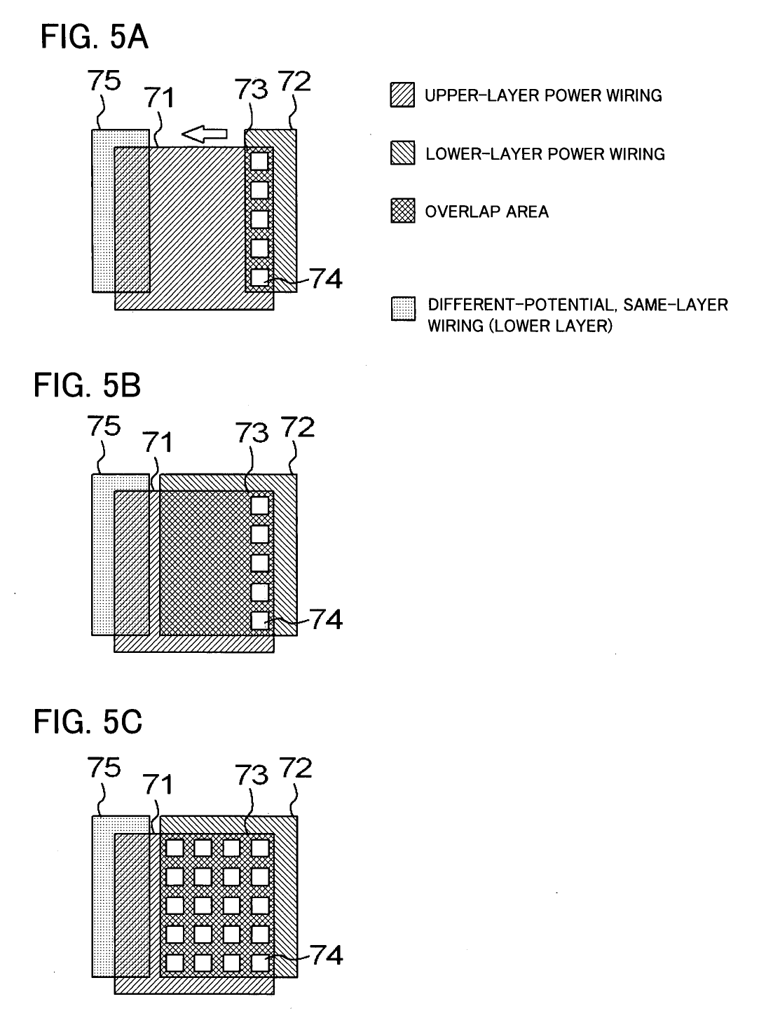

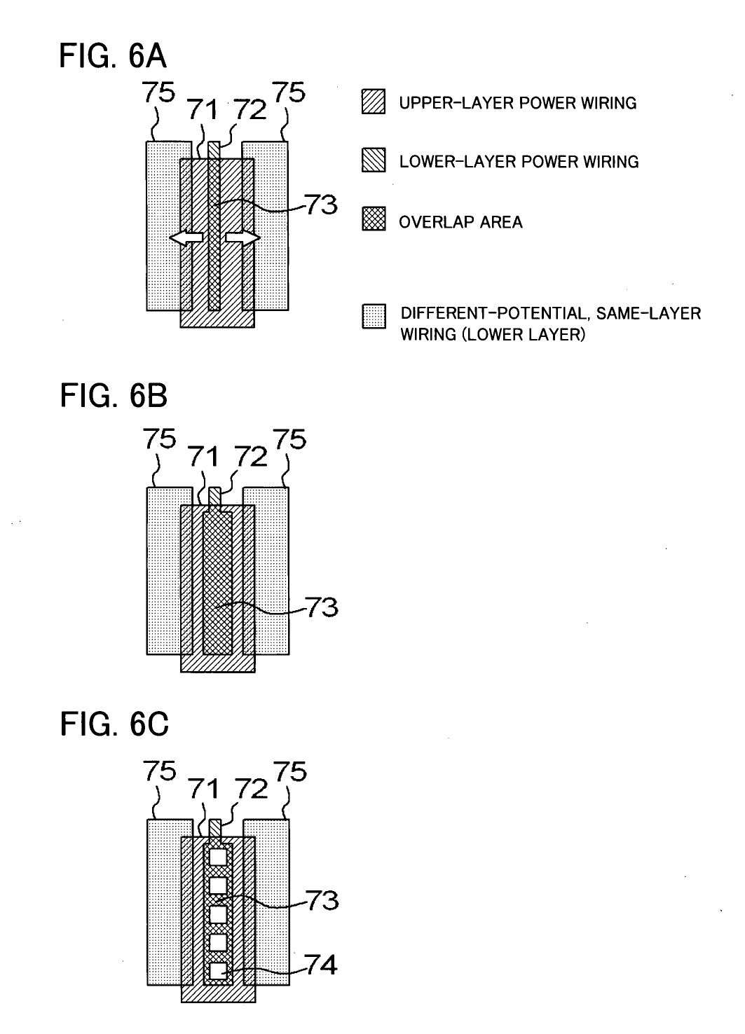

Next, at step S107 (determine whether overlap area can be enlarged), it is determined by the power-wiring enlargement determination function 52c whether the overlap area extracted at step S102 can be enlarged. By way of example, as illustrated in FIG. 5A, assume that through-holes 74 have already been formed in the area 73 of overlap between the upper-layer power wiring 71 and lower-layer power wiring 72, which are at the same potential, and that there is no space in which through-hole can be placed anew. On the other hand, as illustrated in FIG. 6A, assume that the space available in the overlap area 73 is too small to allow the placement of through-holes. Whether it is possible to enlarge the overlap area 73 in this case is determined by enlarging at least the upper-layer power wiring 71 or lower-layer power wiring 72 or both. By extending the lower-layer power wiring 72 leftward, as illustrated in FIG. 5B, in such a manner that it is not allowed to touch different-potential, same-layer wiring 75, the overlap area 73 can be enlarged in the manner shown. Further, by extending the lower-layer power wiring 72 leftward and rightward, as illustrated in FIG. 6B, in such a manner that it is not allowed to touch different-potential, same-layer wiring 75 on both sides, the overlap area 73 can be enlarged in the manner shown. If it has thus been determined that the overlap area can be enlarged, the power wiring is enlarged by the power-wiring revision function 52d at step S108 (enlarge overlap area) and the enlarged overlap area is extracted by the overlap-area extraction function 52b. Next, at steps S109 to S112, through-holes are laid out (see FIGS. 5C and 6C) in a manner similar to that of steps S103 to S106 described above. However, if it is determined at step S110 that through-holes cannot be placed in the enlarged overlap area because of inadequate space, etc., then the enlarged overlap area is restored to the original overlap area by the power-wiring revision function 52d at step S113 (cancel enlargement of overlap area). On the other hand, if it is determined at step S107 that enlargement of the overlap area is not possible, control proceeds to step S114.

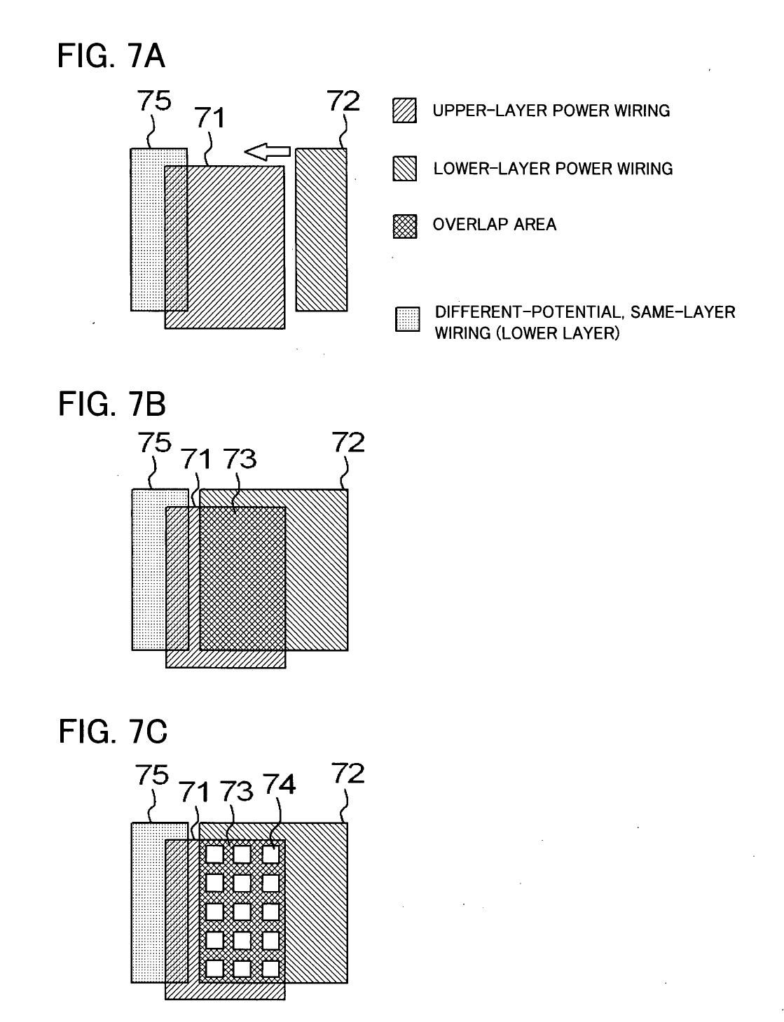

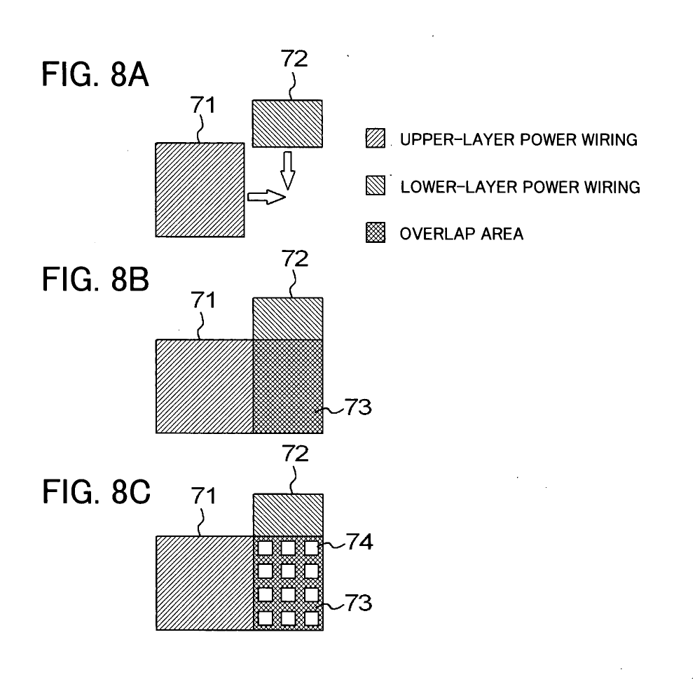

Next, at step S114 (determine whether overlap area can be formed), whether formation of a new overlap area is possible or not is determined by the power-wiring enlargement determination function 52c. By way of example, assume that there is no area of overlap between the upper-layer power wiring 71 and lower-layer power wiring 72 of the same potential, as illustrated in FIG. 7A or 8A. Whether it is possible to form a new overlap area in this case is determined by enlarging at least the upper-layer power wiring 71 or lower-layer power wiring 72 or both. By extending the lower-layer power wiring 72 leftward, as illustrated in FIG. 7B, in such a manner that it is not allowed to touch different-potential, same-layer wiring 75, the overlap area 73 can be formed anew in the manner shown. Further, by extending both the upper-layer power wiring 71 and the lower-layer power wiring 72, as illustrated in FIG. 8B, in such a manner that it is not allowed to touch different-potential, same-layer wiring (not shown), the overlap area 73 can be formed anew in the manner shown. If it has thus been determined that an overlap area can be formed, then power wiring is enlarged by the power-wiring revision function 52d at step S115 (form overlap area) and the enlarged overlap area is extracted by the overlap-area extraction function 52b. Next, at steps S116 to S119, through-holes are laid out (see FIGS. 7C and 8C) in a manner similar to that of steps S108 to S112 described above. However, if it is determined at step S117 that through-holes cannot be placed in the newly formed overlap area because of inadequate space, etc., then the formation of the overlap area is cancelled at step S120 (cancel formation of overlap area) in a manner similar to that of step S113 described above. On the other hand, if it is determined at step S114 that formation of the overlap area is not possible, then placement of the through-holes is completed.

In accordance with the first example of the present invention, layout of through-holes can be designed, without leaving out areas in which placement of through-holes is possible, by enlarging an overlap area and forming an overlap area.

An apparatus and method for designing a semiconductor device according to a second example of the present invention will be described in detail. In accordance with the first example, through-holes are placed sequentially whenever an overlap area in which through-hole placement is possible is extracted. In the second example, placement of through-holes is performed collectively.

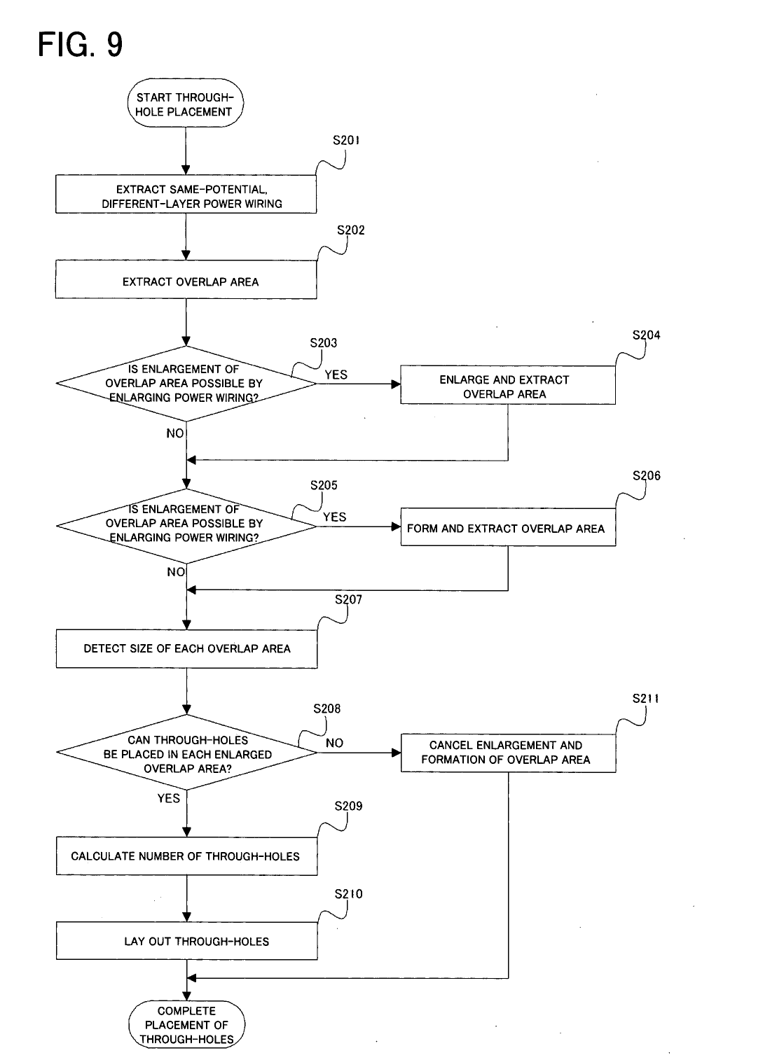

FIG. 9 is a flowchart illustrating the method of designing a semiconductor device according to the second example. Steps S201 and S202 are similar to step S101 (extract same-potential, different-layer power wiring) and step S102 (extract overlap area), respectively of the first example. In the first example, step S103 (detect overlap-area size) and step S104 (determine through-hole layout) are executed next. In the second example, however, the step of determining whether the overlap area can be enlarged is executed at S203. If it is determined that enlargement is possible, then the steps of enlarging the overlap area and extracting the enlarged area are executed at S204. If it is determined that enlargement is not possible, then control proceeds to step S205. Here it is determined whether an overlap area can be formed. If it is determined that formation is possible, then the steps of forming the overlap area and extracting the overlap area are executed at S206. If it is determined that formation is not possible, then control proceeds to step S207.

In the second example, the sizes of each of the extracted overlap areas are all detected at one time at step S207. Next, at step S208, it is determined whether through-hole can be laid out in each overlap area. With regard to overlap areas in which it has been determined that placement of through-holes is possible, the steps of calculating the number of through-holes and placing the through-holes are executed at S209 and S210, respectively. With regard to overlap areas in which it has been determined that placement of through-holes is not possible, the step of canceling enlargement of the overlap area or canceling formation of the overlap area is executed at S211.

A structure similar to the apparatus for designing a semiconductor device according to the first example can be adopted for that of the apparatus according to the second example.

In accordance with the second example, layout of through-holes can be designed more efficiently than in the first example by executing the through-hole layout steps collectively.

Next, an apparatus and method for designing a semiconductor device according to a third example of the present invention will be described in detail. In the first and second examples, the enlargement of same-potential, different-layer power wiring is performed after an overlap area is extracted. In the third example, however, the enlargement of same-potential, different-layer power wiring is performed en masse before an overlap area is extracted, then the overlap areas are extracted all at once.

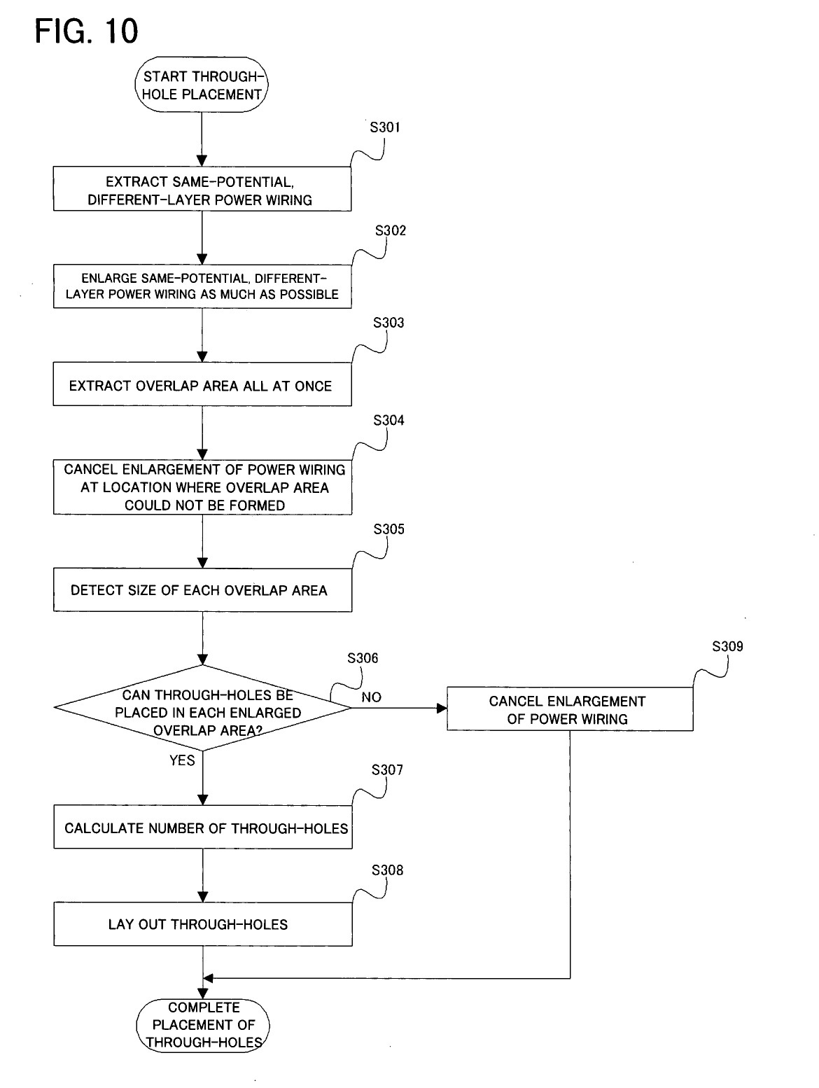

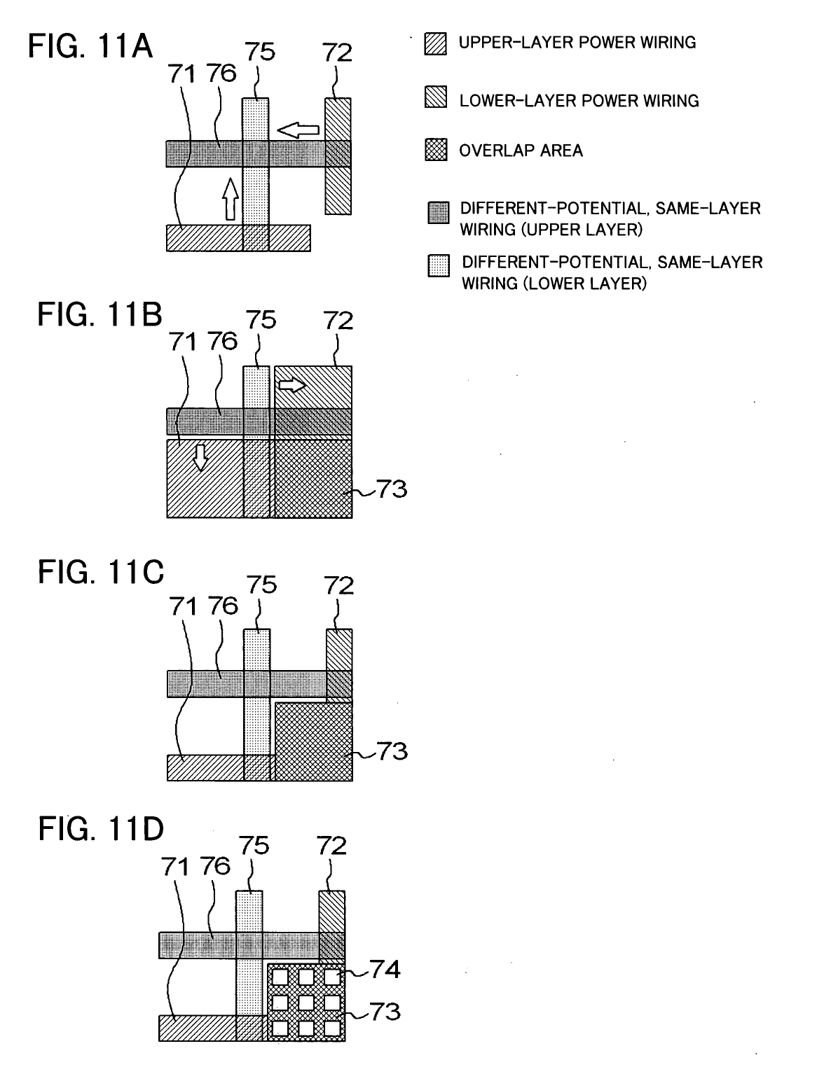

FIG. 10 is a flowchart illustrating the method of designing a semiconductor device according to a third example. FIGS. 11A to 11D are planar projection diagrams of power wiring useful in describing a method of designing a semiconductor device according to the third example. First, at step S301, same-potential, different-layer power wiring traces 71, 72 are extracted (FIG. 11A). Next, at step S302 (enlarge power wiring), the same-potential, different-layer power wiring traces 71, 72 are enlarged en masse before an area of overlap between these power wiring traces 71, 72 is extracted. At this time the same-potential, different-layer power wiring traces 71, 72 are enlarged as much as possible (e.g., until just before contact is made with different-potential, same-layer power wiring 75, 76) (FIG. 11B). Next, at step S303, area (areas) 73 of overlap between the enlarged same-potential, different-layer power wiring traces 71, 72 are extracted at all once. With regard to a location in which an overlap area has not been formed even by enlargement of the same-potential, different-layer power wiring traces 71, 72 at step S302, enlargement of the same-potential, different-layer power wiring traces 71, 72 is cancelled (the state that prevailed prior to enlargement is restored) at step S304 (cancel enlargement of power wiring) (see FIG. 11C). It should be noted that the step of canceling enlargement of the power wiring at step S304 may be performed at step S309 later on.

Next, at steps S305 to S308, processing similar to that of steps S207 to S210 of the second example is executed (see FIG. 11D). With regard to an overlap area formed by enlargement at step S302 and for which it has been determined at step S306 that placement of through-holes is not possible, the enlargement of the same-potential, different-layer power wiring traces 71, 72 is cancelled at step S309.

A structure similar to the apparatus for designing a semiconductor device according to the first example can be adopted for that of the apparatus according to the third example.

In accordance with the third example of the present invention, the process of extracting an overlap area can be completed in a single operation by extracting the overlap area after enlarging the power wiring en masse. In addition, it is unnecessary to divide the enlargement of power wiring into a number of stages, as in the step of enlarging an overlap area and the step of forming an overlap area. Accordingly, layout of through-holes can be designed more efficiently than in the second example.

The apparatus and method for designing semiconductor devices according to the present invention are not limited to those of the foregoing examples, and various modifications and improvements can be made within the scope of the invention. For example, the assignment of the functions of the design apparatus of the present invention to the various units and/or functional units is not limited to that illustrated in FIG. 1, and a different assignment or combination of assignments is possible. Further, naturally it is possible for a plurality of the functions illustrated in FIG. 1 to be consolidated into a single function or for a single function to be divided into a plurality of functions. Furthermore, although the functions executed at the plurality of steps are illustrated generally in the form illustrated in FIG. 1, it goes without saying that each individual function can be illustrated on a per-step basis. The method of designing a semiconductor device according to the present invention is such that steps can be added on or deleted, and the order of the steps can be changed as appropriate. In the first example, for example, both the step of enlarging an overlap area and the step of forming an overlap area are executed. However, the invention may be practiced in a form in which only one of these steps is implemented.

It should be noted that the apparatus for designing semiconductor devices shown in FIG. 1 is illustrated only in terms of the major components that are relevant to the present invention, and illustration of all of the components of the design apparatus of the invention is not intended. Similarly, the flowcharts shown in FIGS. 2, 9 and 10 illustrate only the major steps that are relevant to the present invention, and illustration of all of the steps included in the design method of the invention is not intended.

The apparatus and method for designing semiconductor devices according to the present invention are applicable to semiconductor devices such as semiconductor elements, integrated circuits and printed circuit boards. Further, application of the present invention is not limited to the strengthening of a power supply; the invention can also be applied as means for reinforcing signal wiring.

As many apparently widely different examples of the present invention can be made without departing from the spirit and scope thereof, it is to be understood that the invention is not limited to the specific examples thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A method of designing a semiconductor device, comprising:
a same-potential, different-layer power wiring extraction step of extracting same-potential, different-layer power wiring traces from among power wiring traces that have been designed;
an overlap-area extraction step of extracting an overlap area in which the same-potential, different-layer power wiring traces overlap each other in a planar projection of the same-potential, different-layer power wiring traces that have been extracted;
an overlap-area enlargement step of enlarging the overlap area by enlarging at least one of the same-potential, different-layer power wiring traces without this wiring trace being allowed to touch a different-potential, same-layer wiring trace; and
a through-hole layout step of laying out through-holes in the overlap area.

2. A method of designing a semiconductor device, comprising:
a same-potential, different-layer power wiring extraction step of extracting same-potential, different-layer power wiring traces from among power wiring traces that have been designed;
an overlap-area extraction step of extracting an overlap area in which the same-potential, different-layer power wiring traces overlap each other in a planar projection of the same-potential, different-layer power wiring traces that have been extracted;
an overlap-area formation step of forming a new overlap area by enlarging at least one of the same-potential, different-layer power wiring traces without this wiring trace being allowed to touch a different-potential, same-layer wiring trace; and
a through-hole layout step of laying out through-holes in the overlap area.

3. A method of designing a semiconductor device, comprising:
a same-potential, different-layer power wiring extraction step of extracting same-potential, different-layer power wiring traces from among power wiring traces that have been designed;
an overlap-area extraction step of extracting an overlap area in which the same-potential, different-layer power wiring traces overlap each other in a planar projection of the same-potential, different-layer power wiring traces that have been extracted;
an overlap-area enlargement step of enlarging the overlap area by enlarging at least one of the same-potential, different-layer power wiring traces without this wiring trace being allowed to touch a different-potential, same-layer wiring trace;
an overlap-area formation step of forming a new overlap area by enlarging at least one of the same-potential, different-layer power wiring traces without this wiring trace being allowed to touch a different-potential, same-layer wiring trace; and
a through-hole layout step of laying out through-holes in the overlap areas.

4. A method of designing a semiconductor device, comprising:
a same-potential, different-layer power wiring extraction step of extracting same-potential, different-layer power wiring traces from among power wiring traces that have been designed;
a power wiring enlargement step of enlarging at least one of the same-potential, different-layer power wiring traces without this wiring trace being allowed to touch a different-potential, same-layer wiring trace;
after said power wiring enlargement step, an overlap-area extraction step of extracting an overlap area in which the same-potential, different-layer power wiring traces overlap each other in a planar projection of the same-potential, different-layer power wiring traces that have been extracted; and
a through-hole layout step of laying out through-holes in the overlap area.

5. The method according to claim 4, further comprising a power wiring enlargement cancellation step executed after said power wiring enlargement step if a portion enlarged by said power wiring enlargement step in the same-potential, different-layer power wiring does not form the overlap area, said power wiring enlargement cancellation step canceling enlargement of the power wiring in the portion that does not form the overlap area to restore a condition that prevailed prior to the enlargement.

6. An apparatus for designing a semiconductor device, comprising:
a same-potential, different-layer power wiring extraction function that extracts same-potential, different-layer power wiring traces from among power wiring traces that have been designed;
an overlap-area function that extracts an overlap area in which the same-potential, different-layer power wiring traces overlap each other in a planar projection of the same-potential, different-layer power wiring traces that have been extracted;
a power-wiring enlargement determination function that determines whether it is possible to enlarge the same-potential, different-layer power wiring without this power wiring touching different-potential, same-layer wiring, whether it is possible to enlarge the overlap area by enlarging the same-potential, different-layer power wiring, and whether it is possible to form an overlap area anew by enlarging the same-potential, different-layer power wiring;
a power-wiring revision function that enlarges the same-potential, different-layer power wiring and cancels enlargement based upon result of determination by said power-wiring enlargement determination function; and
a through-hole layout function that lays out through-holes in the overlap area.

7. The apparatus according to claim 6, further comprising:
an overlap-area size detection function that detects the size of the overlap area;
a through-hole layout determination function that determines whether through-holes are capable of being placed in the overlap area; and
a through-hole number calculation function that calculates the number of through-holes capable of being placed in the overlap area.
